(19) United States
(12) Patent Application Publication
(10) Pub. No.: US 2026/0230307 A1
(43) Pub. Date: Aug. 6, 2026

(54) HIERARCHICAL KEY MANAGEMENT SYSTEM

(71) Applicant: OKTA, INC., SAN FRANCISCO, CA (US)

(72) Inventors: Alexandre GONZÁLEZ RODRÍGUEZ, Vacallo (CH); Gatewood C. GREEN, JR., Cottonwood, AZ (US); Ian HASSARD, Kitchener (CA); Niki VAN CLEEMPUT, Kleine Brogel (BE); Riccardo COCETTA, Antibes (FR); Sam MUNCKE, London (GB)

(21) Appl. No.: 19/043,246

(22) Filed: Jan. 31, 2025

(51) Int. Cl. H04L 9/08; H04L 9/40

(52) U.S. Cl. CPC H04L 9/0836; H04L 9/0894; H04L 63/0428

(57) ABSTRACT

A computing system may receive, at a server, a first request from a user, the first request for encryption of a set of data. The server may transmit, to a key management system, a second request for a data encryption key associated with the set of data indicated via the first request. The server may receive, from the key management system and in response to the second request, the data encryption key being associated with encrypting the set of data and a reference of a namespace key, the namespace key being associated with a different level in the key hierarchy of the key management system than the data encryption key. The server may store an encrypted version of the set of data, the data encryption key, and the reference of the namespace key based on receiving the data encryption key from the key management system.

### FIELD OF TECHNOLOGY

The present disclosure relates generally to identity management, and more specifically to a hierarchical key management system.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

In some examples, computing systems may be utilized to store encrypted data for users. In some cases, the data may be encrypted by one or more keys. In some cases, the one or more keys may ensure the security of data utilizing cryptography techniques. In some examples, the one or more keys may be managed and inadequate management of keys can result in one or more security risks. Further, the one or more keys may have a relatively low level of granularity which may result in access control issues and further security risks,

### SUMMARY

A method for data encryption by a server is described. The method may include receiving, at the server, a first request from a first user, the first request for encryption of a set of data, transmitting, to a key management system, a second request for a data encryption key associated with the set of data indicated via the first request, the key management system including a key hierarchy for data encryption and decryption, receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system, and storing, at the server, an encrypted version of the set of data, the data encryption key, and the reference of the namespace key based on receiving the data encryption key from the key management system.

A server for data encryption is described. The server may include one or more memories storing processor executable code, and one or more processors coupled with the one or more memories. The one or more processors may individually or collectively be operable to execute the code to cause the server to receive, at the server, a first request from a first user, the first request for encryption of a set of data, transmit, to a key management system, a second request for a data encryption key associated with the set of data indicated via the first request, the key management system including a key hierarchy for data encryption and decryption, receive, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system, and store, at the server, an encrypted version of the set of data, the data encryption key, and the reference of the namespace key based on receiving the data encryption key from the key management system.

Another server for data encryption is described. The server may include means for receiving, at the server, a first request from a first user, the first request for encryption of a set of data, means for transmitting, to a key management system, a second request for a data encryption key associated with the set of data indicated via the first request, the key management system including a key hierarchy for data encryption and decryption, means for receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system, and means for storing, at the server, an encrypted version of the set of data, the data encryption key, and the reference of the namespace key based on receiving the data encryption key from the key management system.

A non-transitory computer-readable medium storing code for data encryption is described. The code may include instructions executable by one or more processors to receive, at the server, a first request from a first user, the first request for encryption of a set of data, transmit, to a key management system, a second request for a data encryption key associated with the set of data indicated via the first request, the key management system including a key hierarchy for data encryption and decryption, receive, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system, and store, at the server, an encrypted version of the set of data, the data encryption key, and the reference of the namespace key based on receiving the data encryption key from the key management system.

Some examples of the method, servers, and non-transitory computer-readable medium described herein may further include operations, features, means, or instructions for transmitting, to the key management system, a first application programming interface (API) request that includes the second request, the first API request associated with creating the data encryption key associated with the set of data and receiving, from the key management system and in response to the first API request, a first API response that includes the data encryption key associated with encrypting the set of data into the encrypted version of the set of data and the reference of the namespace key.

Some examples of the method, servers, and non-transitory computer-readable medium described herein may further include operations, features, means, or instructions for transmitting, to the key management system, a second API request that includes a fourth request for decryption of an encrypted version of the data encryption key to decrypt the encrypted version of the set of data, the fourth request including an indication of the encrypted version of the data encryption key associated with the encrypted version of the set of data and including the reference of the namespace key, where the server encrypts the data encryption key to obtain the encrypted version of the data encryption key, and where transmission of the second API request may be based on a decrypted version of the data encryption key being unavailable at a cache of the server and receiving, from the key management system, a second API response that includes the decrypted version of the data encryption key in response to the second API request that includes the fourth request.

In some examples of the method, servers, and non-transitory computer-readable medium described herein, the namespace key may be a first version of the namespace key and the method, apparatuses, and non-transitory computer-readable medium may include further operations, features, means, or instructions for receiving, from the key management system, an indication of a reference to a second version of the namespace key to associate with the data encryption key based on a key rotation procedure, the second version of the namespace key being different from the first version of the namespace key, where the key rotation procedure refrains from re-encrypting the encrypted version of the set of data and storing, at the server, the first version of the namespace key in a list of previous namespace key versions based on receiving the reference to the second version of the namespace key.

In some examples of the method, servers, and non-transitory computer-readable medium described herein, storing the data encryption key may include operations, features, means, or instructions for storing the data encryption key within one or more caches at the server and at the key management system.

In some examples of the method, servers, and non-transitory computer-readable medium described herein, the key hierarchy includes a root key, a set of multiple tenant keys, a set of multiple namespace keys that includes the namespace key, and a set of multiple data encryption keys that includes the data encryption key.

In some examples of the method, servers, and non-transitory computer-readable medium described herein, the root key may be associated with each other key in the key hierarchy.

In some examples of the method, servers, and non-transitory computer-readable medium described herein, each tenant of a set of multiple tenants may be associated with one or more different tenant keys of the set of multiple tenant keys.

In some examples of the method, servers, and non-transitory computer-readable medium described herein, the set of multiple namespace keys may be associated with one or more services, one or more applications, or both.

In some examples of the method, servers, and non-transitory computer-readable medium described herein, the set of multiple namespace keys includes one or more private namespace keys for encryption of private data.

In some examples of the method, servers, and non-transitory computer-readable medium described herein, the key hierarchy indicates that one or more data encryption keys of the set of multiple data encryption keys may be encrypted by a respective namespace key of the set of multiple namespace keys, one or more name space keys of the set of multiple namespace keys may be encrypted by a respective tenant key of the set of multiple tenant keys, and one or more tenant keys of the set of multiple tenant keys may be encrypted by the root key.

In some examples of the method, servers, and non-transitory computer-readable medium described herein, the root key may be hosted by and stored at a cloud platform associated with the key management system or may be associated with the first user.

In some examples of the method, servers, and non-transitory computer-readable medium described herein, the first user may be associated with a first tenant and the namespace key may be associated with a tenant key for the first tenant, the tenant key associated with a different level in the key hierarchy of the key management system than a level of the namespace key in the key hierarchy of the key management system.

In some examples of the method, servers, and non-transitory computer-readable medium described herein, a respective key in the key hierarchy of the key management system may be within a respective state of a set of multiple states, the set of multiple states including a pre-activation state, an active state, a deactivated state, a destroyed state, or any combination thereof.

In some examples of the method, servers, and non-transitory computer-readable medium described herein, the server may be an authentication server, a web server, a cloud-based server, a database server, an application server, a physical server, a virtual server, or any combination thereof.

### BRIEF DESCRIPTION OF THE DRAWINGS

FIG. 1 illustrates an example of a computing system that supports a hierarchical key management system in accordance with aspects of the present disclosure.

FIG. 2 shows an example of a computing system that supports a hierarchical key management system in accordance with aspects of the present disclosure.

FIG. 3 shows an example of a key hierarchy diagram that supports a hierarchical key management system in accordance with aspects of the present disclosure.

FIG. 4 shows an example of a process flow that supports a hierarchical key management system in accordance with aspects of the present disclosure.

FIG. 5 shows a block diagram of an apparatus that supports a hierarchical key management system in accordance with aspects of the present disclosure.

FIG. 6 shows a block diagram of a data encryption service that supports a hierarchical key management system in accordance with aspects of the present disclosure.

FIG. 7 shows a diagram of a system including a device that supports a hierarchical key management system in accordance with aspects of the present disclosure.

FIG. 8 shows a flowchart illustrating methods that support a hierarchical key management system in accordance with aspects of the present disclosure.

### DETAILED DESCRIPTION

In some examples, for encryption and decryption of data, computing systems may utilize one or more keys. The one or more keys may be referred to as cryptography keys (or cryptographic keys). The keys may be utilized to ensure that data is accessed by authorized entities and to prevent unauthorized access to encrypted data, which may include sensitive data. To encrypt data with a key, the computing system may first generate a cryptographic key, which may then be used to encrypt data, transforming the data into an unreadable format that can only be reverted to an original state (and readable format) through decryption using the same or a corresponding key. In some cases, such a mechanism may enable the safeguarding of data while being transmitted between devices or services or while being stored, preventing unauthorized access and ensuring data integrity. However, the management of such keys, including the secure storage of the one or more keys, distribution, lifecycle management, or any combination thereof may present relatively significant security challenges. For example, without a robust system to handle the storage, distribution, and lifecycle management of one or more keys, a system (e.g., an identity management system or other type of computing system) may be at risk of key exposures and data loss, thus presenting one or more security risks or vulnerabilities.

In accordance with the techniques of the present disclosure, a key management system may be utilized to facilitate the secure generation, storage, and use of one or more keys, enabling efficient and secure encryption and decryption of data. For example, a computing system may receive, at a server of the computing system, a first request from a first user to encrypt a set of data. In response, the server of the computing system may transmit, to a key management system, a second request for a data encryption key associated with the set of data (e.g., encryption of the set of data) indicated via the first request. Moreover, the key management system may include a key hierarchy for data encryption and decryption. The server of the computing system may then receive, from the key management system and in response to the second request, the data encryption key associated with encrypting the set of data and a reference of a namespace key. The namespace key may be associated with a different level in the key hierarchy of the key management system than a level of the data encryption key. Further, based on receiving the data encryption key from the key management system, the server may store an encrypted version of the set of data, the data encryption key, and the reference of the namespace key. By having the key management system utilize a key hierarchy and providing the server with data encryption key, the computing system may ensure an enhanced level of security of data, thus improving the reliability of the computing system.

In some cases, the key hierarchy of the key management system may include a root key, one or more tenant keys, one or more namespace keys, and one or more data encryption keys. Further, based on the key hierarchy, only the data encryption keys may be shared outside of the key management system to reduce the likelihood of unauthorized access to data. For example, to access encrypted data stored within the server, a user or service may have to provide both an encrypted version of the data encryption key and the reference to the namespace key to the key management system to decrypt the data. In some cases, the data encryption key stored at the server may be encrypted by the namespace key, as such, to decrypt data associated with the data encryption key, the server may transmit, to the key management system, a request for a decrypted version of the data encryption key by including the encrypted version of the data encryption key and the reference to the namespace key. Moreover, to further enhance the security of data, the key management system may perform one or more key rotation procedures. Within a key rotation procedure, the key management system may change the value of one or more keys while refraining from changing the data encryption keys, thus preventing having to re-encrypt data at the storage which may be time-consuming and computationally expensive.

Thus, implementing the key management system into a computing system may enhance the security of data storage by addressing one or more complexities and vulnerabilities of previous key management techniques. For example, by implementing a key hierarchy, a computing system may reduce the risk of a key exposure. Moreover, as each key in the key hierarchy may encrypt the key in below levels, the key management system may be relatively secure. Further, in accordance with the techniques of the present disclosure, the key management system may provide efficient techniques for key rotations that prevent having to re-encrypt data, thus ensuring a relatively high level of performance and a relatively low level of latency associated with the key rotations. In some examples, the key management system may also support a relatively higher level of granularity for access control, ensuring that only authorized users and services can access respective keys, resulting in enhanced security and compliance with data protection regulations for computing systems. Additionally, or alternatively, in accordance with the techniques of the present disclosure, the key management system may be capable of being implemented in a multi-tenant environment, thus improving the functionality and scalability of computing systems.

Aspects of the disclosure are initially described in the context of a computing system. Additional aspects of the disclosure are described with reference to a computing system, a key hierarchy diagram Aspects of the disclosure are further illustrated by and described with reference to apparatus diagrams, system diagrams, and flowcharts that relate to a hierarchical key management system.

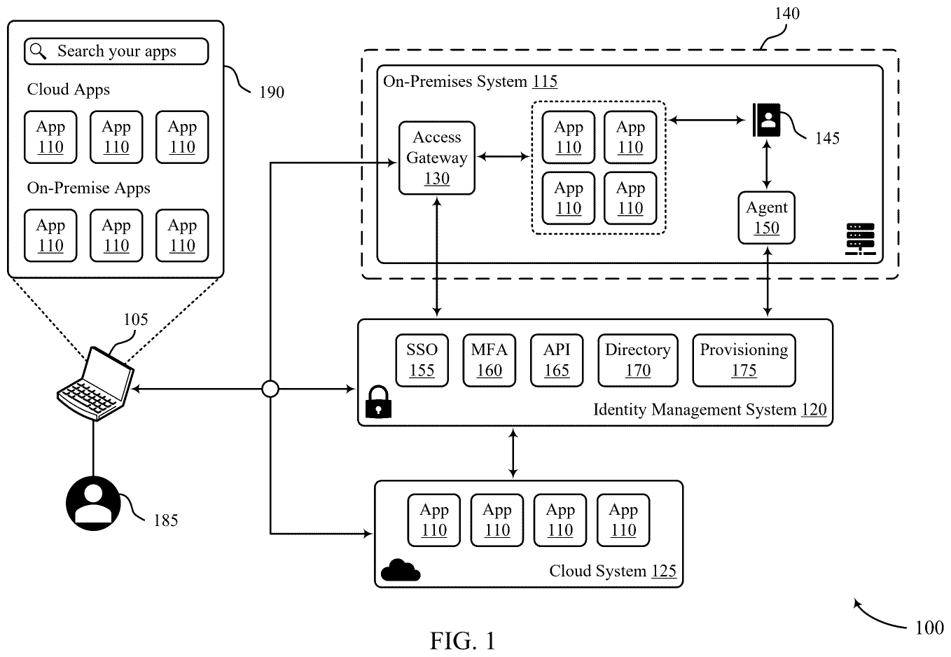

FIG. 1 illustrates an example of a computing system 100 that supports a hierarchical key management system in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs.The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

In some examples of the computing system 100, a key management system may be utilized to facilitate the secure generation, storage, and use of one or more keys, enabling efficient and secure encryption and decryption of data within the identity management system 120. For example, the computing system 100 that includes the identity management system 120 may receive, at a server, a first request from a first user to encrypt a set of data. In response, the server of the computing system 100 may transmit, to a key management system, a second request for a data encryption key associated with the set of data (e.g., encryption of the set of data) indicated via the first request. Moreover, the key management system may include a key hierarchy for data encryption and decryption. The server of the computing system 100 may then receive, from the key management system and in response to the second request, the data encryption key being associated with encrypting the set of data and a reference of a namespace key. The namespace key may be associated with a different level in the key hierarchy of the key management system than a level of the data encryption key in the key hierarchy of the key management system. Further, based on receiving the data encryption key from the key management system, the server may store an encrypted version of the set of data, the data encryption key, and the reference of the namespace key. Moreover, by having the key management system utilize a key hierarchy and providing the server with the data encryption key, the computing system 100 may ensure an enhanced level of security of data, thus improving the reliability of the computing system 100.

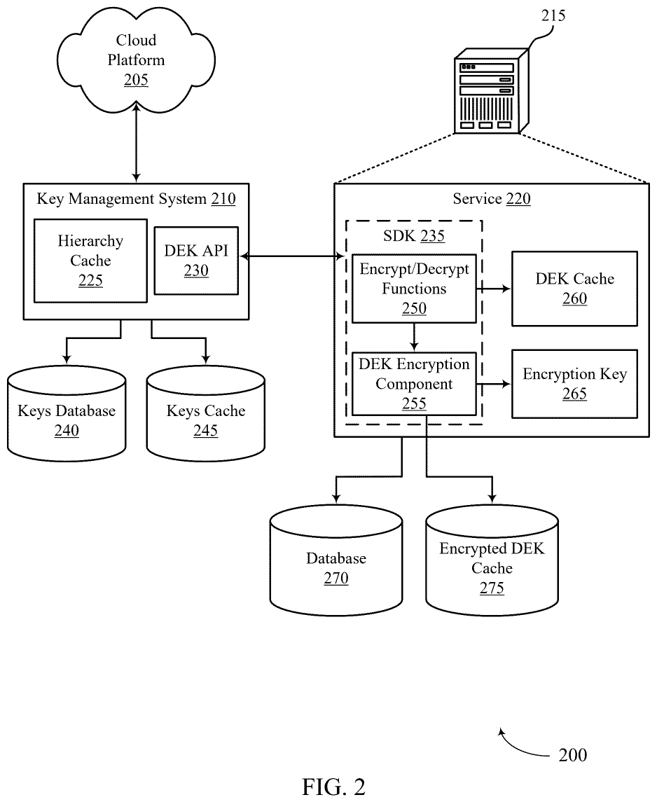

FIG. 2 shows an example of a computing system 200 that supports a hierarchical key management system in accordance with aspects of the present disclosure. In some examples, the computing system 200 may implement or be implemented by the computing system 100. For example, the computing system 200 may include a cloud platform 205, a key management system 210, a server 215, and a service 220, which may be examples of devices or services described herein with reference to FIG. 1. In some examples, the cloud platform 205 may be associated with the key management system 210 and the server 215 may support the service 220.

Within the computing system 200, the security of information may be protected and provided by one or more cryptographic modules that are dependent on the secure management of cryptographic keys. In accordance with the techniques of the present disclosure, the key management system 210 may manage the lifecycle management of cryptographic keys from generation, storage, and distribution, to the destruction or rollback of the cryptographic keys. The key management system 210 may be configured to provide a robust and secure system for developers to ensure that developers can securely store, manage, and utilize keys within a multi-tenant environment. Moreover, the key management system 210 may mitigate one or more threats associated with key management.

The key management system 210 may be an example of an end-to-end cryptosystem that provides key lifecycle management, logical access to key servers, and user access to encryption keys. In some examples, the key lifecycle may include key generation, pre-activation, activation, suspension, deactivation, compromise, and destruction of one or more keys. Further, the key management system 210 may provide the computing system 200 with a predictable life cycle where keys are activated before use, suspended when needed, and deactivated or destroyed after an acceptable use.

In some examples, the key lifecycle of the key management system 210 may include one or more states and one or more state transitions. In some cases, each state may enforce a permitted key usage. For a pre-activation state, a respective key may exist but is unable to be used. For active state, the key can be used for both encryption and decryption. For a deactivated state, the key can be used to decrypt previously encrypted data but is unavailable to be used to encrypt data or to decrypt data that has yet to be decrypted. For a destroyed state, a key may be unavailable for any purposes. Moreover, a crypto period of a key may also be used to express or indicate a lifecycle of the key. Further, implementing the key lifecycle may improve the security of the computing system 200. Additionally, or alternatively, it should be understood by one having ordinary skill in the art that the one or more states of the key lifecycle may include any quantity of states.

In some examples, the key management system 210 may utilize an encryption/decryption as-a-Service (aaS) approach to encrypt and decrypt data or keys. For example, the key management system 210 may include one or more APIs for key management operations (e.g., key hierarchy creation, rekeying), encryption/decryption of data (e.g., via an Encryption-as-a-Service (EaaS), and data encryption key operations.

In some examples, the key management system 210 may securely generate and store keys. For example, the key management system 210 may securely generate key material, manage storage of keys and corresponding metadata in a secure manner, and provide access to the correct keys and the correct time (e.g., in response to requests). Further, the key management system 210 may be a centralized system or service within the computing system 200 that provides the computing system 200 the capability to perform key management, auditing, and to support access control procedures and third-party integrations. In some cases, the key management system 210 may have built-in auditing capabilities for users or services to audit the access to keys.

To provide management of keys, in accordance with the techniques of the present disclosure, the key management system 210 may implement a key hierarchy. The key hierarchy may establish a root key for data protection and the key management system 210 may store the root key within the cloud platform 205. When an instance of the cloud platform 205 is initialized, access to the root key may be established by the key management system 210 and the key management system 210 may use the root key as a basis for access to all subsequent keys within the environment.

In some examples, to meet the compliance and security requirements of customers or users, the root key may reside or be stored with a hardware service module (HSM) such as the cloud platform 205. In some cases, the cloud platform 205 may be an example of a cloud-based key vault. Below the root key, the key management system 210 may establish one or more tenant master keys (TMKs) for each tenant utilizing an identity management system that implements the key management system 210. Thus, each tenant within the identity management system may have one or more different tenant master keys. In a public cloud deployment, the term “tenant” may refer to an individual customer or user. However, in some cases, a customer may have multiple accounts and thus each account may be a separate tenant. In a private cloud instance, the term “tenant” may refer to a customer environment.

Since each tenant may be associated with a unique tenant master key, sensitive data that is tenant-specific may be protected by the key hierarchy and can be efficiently and securely deleted by deletion of the tenant master key and any corresponding backups of the tenant master key. Once the tenant master key is completely deleted, all the protected data may be rendered unreadable and useless.

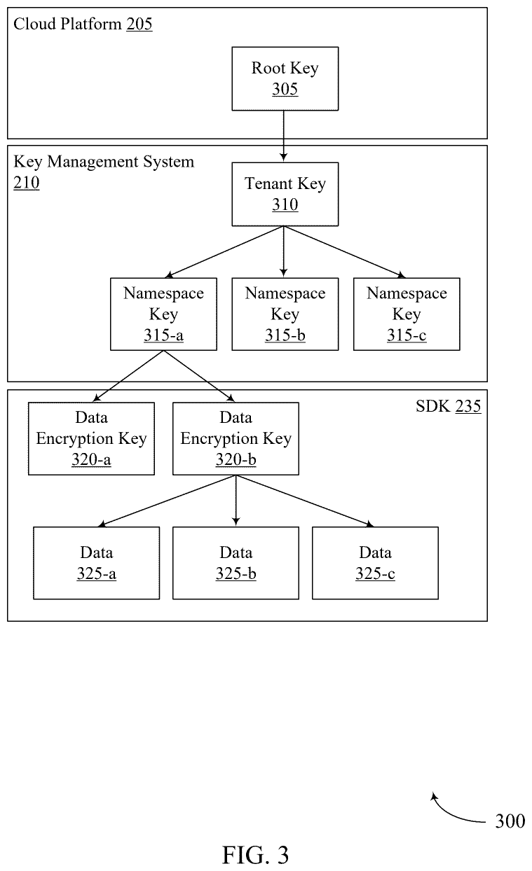

Further, underneath a respective tenant master key may be one or more signing keys and one or more namespace keys. The key management system 210 may implement the one or more signing keys for data signing operations. In some cases, one or more signing keys may be used to reduce the likelihood of private key leakage into a service log. Further, a compromise of the computing system 200 may not automatically access the one or more signing keys. For example, a malicious user may be able to utilize a key via an API call to the key management system 210 but may be unable to access the one or more signing keys. Further, the namespace keys may represent the mechanism to encrypt data for storage within the key management system 210. Moreover, below the namespace keys may be one or more data encryption keys used to directly encrypt data. Further descriptions of the key hierarchy may be described elsewhere herein, such as with reference to FIG. 3.

The key management system 210 may also be associated with a namespace key cache 225 and a data encryption key API 230. In some cases, the namespace key cache 225 may enable the key management system 210 to store one or more namespace keys for efficient and low-latency access. In some examples, a cache may be an example of a relatively high-speed storage layer that temporarily holds or stores frequently accessed data to improve retrieval times and enhance overall system performance. The data encryption key API 230 may enable communications and interactions between the key management system 210 and a software development kit (SDK) 235 of the service 220. Moreover, the key management system 210 may coordinate with a keys database 240 to store one or more keys and a keys cache 245 for relatively fast access to one or more keys.

In some examples, the service 220 may be an example of an encryption service that can encrypt and decrypt remote procedure calls (RPCs) to callers. The service 220 may be associated with an SDK 235 that can be referred to as a crypto-SDK. In some cases, the SDK 235 may be a client-side component library that can be utilized by the service 220 to perform cryptography operations. For example, the SDK 235 may provide the service with encryption/decryption functions 250. In some cases, the SDK 235 may also provide the service 220 of the server 215 API access to the key management system 210. Additionally, or alternatively, the SDK 235 may also be associated with a data encryption key component 255 to enable client-side cryptography (e.g., to enable the server to encrypt and decrypt keys for accessing encrypted data). Further, the key management system 210 and the service 220 may be utilized to provide customer-scoped encryption and decryption within the computing system 200. In some cases, to protect and mitigate against accidental key exposure, the SDK 235 may also use one or more key objects to keep encryption keys in memory where possible. Moreover, the service 220 may refrain from sharing data encryption keys outside of the boundary of the SDK 235

In accordance with the techniques of the present disclosure, the key management system 210 and the SDK 235 may reduce security risks of the computing system 200 by generating a system for key management. For example, the key management system 210 may implement and adhere to one or more key management guidelines (e.g., best practices) for key lifecycles and key hierarchy. The computing system 200 may also provide a relatively more flexible compliance to encryption standards. Moreover, the key management system 210 and the SDK 235 may provide crypto agility to the computing system 200 to allow the cryptography techniques to adjust as products evolve and become more complex. Additionally, or alternatively, the computing system 200 may provide a relatively user-friendly approach to cryptography by using the key management system 210 to solve security issues, challenges, and concerns for developers. Further, the key management system 210 may provide the capability for key management audit logging, per-tenant key hierarchies, restrictions to key sharing, and a basis for access control.

In some cases, the SDK 235 may also provide an efficient and easy-to-user abstraction for utilizing the key management system 210. For example, the SDK 235 may wrap all calls to the key management system 210 for security enhancement, handle authentication, and implement one or more protection mechanisms. In some examples, the SDK 235 may also enable developers the capability to encrypt and decrypt data using one or more APIs. Further, the SDK 235 may interact with a data encryption key cache 260. For example, the server 215 may utilize the SDK 235 to access data encryption keys stored in a data encryption key cache 260. In another example, the SDK 235 may utilize the data encryption key component 255 to obtain an encryption key 265 (e.g., an encrypted version of a data encryption key) that can be stored at the server 215. For example, the SDK 235 may use a data encryption key to encrypt data via the decryption functions 250 and then use the data encryption key component 255 to encrypt the data encryption key for storage within the data encryption key cache 260. In some cases, the server 215 may store the encrypted data within a database 270 and the server 215 may store the encrypted version of the data encryption key (e.g., the encryption key 265) with the encrypted data in the database 270. In some other cases, the server 215 may store the encrypted data and the encryption key 265 separately. For example, the server 215 may store the encrypted data within the database 270 and the encryption key 265 within an encrypted data encryption key cache 275.

Further, in accordance with the techniques of the present disclosure, data encryption keys and keys used to encrypt other keys may be stored separately to allow for data encryption to safely and securely be performed on either the service or client side while maintaining the same level of protection on the data encryption keys and tenant master keys. For example, the data encryption keys may be relatively low in terms of sensitivity as the data encryption keys are merely used to encrypt and decrypt the data rather than to encrypt and decrypt other keys.

In some cases, as described herein, to support relatively fast access to data encryption keys, one or more data encryption keys may be cached. When accessing or attempting to access a data encryption key, the server may first determine if the data encryption key is available within the processing memory of the server 215 (e.g., within the data encryption key cache 260). If the data encryption key is unavailable within the data encryption key cache 260, the server 215 may then check the encrypted data encryption key cache 275. If the data encryption key is unavailable within the encrypted data encryption key cache 275, the server 215 may then call to the key management system 210 to either decrypt an encrypted data encryption key or to create an additional (e.g., a new) data encryption key for encryption. In some examples, when caching data encryption keys, the server 215 may cache data encryption keys used for encryption for a relatively longer duration than data encryption keys used for decryption. Additionally, or alternatively, the server 215 may be configured with a maximum duration or a threshold duration that a data encryption key can be cached.

Once a data encryption key is obtained, the server 215 may encrypt a set of data. In some examples, the server 215 may implement envelope encryption for encrypting data. Envelope encryption may be a procedure of encrypting plaintext data with a data encryption key and then encrypting the data encryption key under another key. In accordance with the techniques of the present disclosure, envelope encryption may enable the computing system 200 to enforce a security boundary around the data encryption keys which are shared outside of the key management system 210 and hierarchy keys of the key management system 210 which are not shared outside of the key management system 210. Moreover, the server 215 may use key ciphertexts as a key (e.g., key stored encrypted in the database 270 or the encrypted data encryption key cache 275, but not decrypted before use) when the plaintext version of that ciphertext was expected.

In some cases, data encryption keys may be stored together with the data (encrypted by their corresponding namespace key) in service datastores (e.g., the database 270). For example, the entire envelope is stored as a portion of binary code (e.g., an opaque binary blob data structure where the data is stored in a format such that the data is uncomprehensible) in the service DB in place of the encrypted field. Further, the envelope stored within the database 270 may include an indication of the data encryption key that is encrypted by a namespace key, a reference to the namespace key for use to decrypt the data encryption key, and a portion of cipher text that includes the actual encrypted data that is encrypted by the data encryption key.

In some examples, during operation of the computing system 200, the key management system 210, the cloud platform 205, or both may become disconnected and fail. In accordance with the techniques of the present disclosure, the server 215 may be capable of utilizing the key hierarchy of the key management system 210 even when temporarily losing access to the key management system 210. For example, the server 215 may store a portion of the key hierarchy within a cache at the server, within an external key value cache, or both. Thus, if the server 215 loses access to the key management system 210, the server 215 may still be capable of encrypting and decrypting data. Further, in some cases, the computing system 200 may have multiple cloud platforms 205 that support multiple versions of the key management system 210 such that if a first version of the key management system 210 or a first cloud platform 205 connection is lost, the server 215 may use a different version of the key management system 210 supported by a different cloud platform 205. Therefore, techniques of the present disclosure may ensure resiliency of the key management system 210 and the corresponding key hierarchy.

Further, when deployed, the key management system 210 may be associated with a service for the data encryption key API 230. In some examples, the data encryption key API 230 may enable the key management system 210 to create data encryption keys, unwrap or decrypt existing data encryption keys, or both. Thus, the data encryption key API 230 may enable the server 215 to encrypt and decrypt data without managing a key hierarchy. Moreover, the SDK 235 may enable the server 215 to be capable of utilizing the decryption functions 250 to encrypt and decrypt data. Thus, the SDK 235 may interact with the key management system 210 via the data encryption key API 230 rather than the server 215 interacting with the key management system 210 directly, which may reduce time-consumption associated with encrypting and decrypting data.

In some examples, in accordance with the techniques of the present disclosure, to perform a data read or lookup, the server 215 may first receive an API request to decrypt a set of data. In response, the server 215 may transmit an API request to the database 270 to retrieve the set of data and the data encryption key stored with the set of data. Moreover, since the retrieved set of data and the data encryption key may be encrypted, the server 215 may transmit an API request to the SDK 235 to request a decryption of the set of data. In some cases, such request may include both the encrypted version of the set of data and the encrypted version of the data encryption key. The SDK 235 may then attempt to decrypt the data encryption key utilizing the data encryption key cache 260 and the encrypted data encryption key cache 275. If the SDK 235 can decrypt the data encryption key via a successful hit in the data encryption key cache 260 or the encrypted data encryption key cache 275, the SDK 235 may decrypt the data encryption key and the encrypted set of data accordingly and transmit the decrypted set of data back to the user via an API response. That is, the server 215 may decrypt the set of data without calling the key management system 210.

However, if the SDK 235 is unable to decrypt the encrypted version of the data encryption key directly, the SDK 235 may request, the key management system 210 via the data encryption key API 230, to decrypt the data encryption key. Such a request from the SDK 235 may include an indication of the encrypted version of the data encryption key and a reference to the namespace key used to encrypt the data encryption key but may refrain from including the encrypted version of the set of data. After receiving the request from the SDK 235, the key management system 210 may use the reference to the namespace key to obtain, from the keys database 240 or the keys cache 245, the namespace key used to encrypt the data encryption key and the tenant master key used to encrypt the namespace key. Based on obtaining the namespace key and the tenant master key, the key management system 210 may transmit a request to the cloud platform 205 to decrypt the tenant master key. The cloud platform 205 may then use the root key, which is stored at the cloud platform 205, to decrypt the tenant master key, the key management system 210 may use the decrypted tenant master key to decrypt the namespace key, and the key management system 210 may use the decrypted namespace key to decrypt the data encryption key as requested by the SDK 235. The key management system 210 may then transmit the decrypted data encryption key back to the SDK 235 and the SDK 235 may transmit an API response back to the server 215 that includes the decrypted data encryption key such that the server 215 can decrypt the set of data. Based on decrypting the set of data, the server 215 may transmit an API response back to the user and the API response may include the set of data requested by the user.

Using such procedure, users may be capable of encrypting and decrypting data stored at the server 215 and encrypted in accordance with the key hierarchy of the key management system 210. However, in some cases, while traditional searching of data encrypted at the application level may rely upon database indexing alone, such procedures may be inefficient when using the key management system 210. In some examples, a first strategy to aid in improving application level encrypted data searching may include narrowing the use of application level encryption. For example, the key management system 210 may refrain from encrypting application level data or the computing system 200 may be incapable of searching for application level encrypted data. In another example, the computing system 200 may implement a federated index element as part of the encryption process to facilitate searching of application-level encrypted data within the computing system 200. For example, in addition to encrypting the data, the encryption process can generate a hash of the original clear-text data. Then, when returning from the encryption call, the key management system 210 may supply the SDK 235 of the server 215 with both the encrypted blob (e.g., data structure) and a hash value. The service 220 may store the encrypted data within the database 270 and store the hash in a separate index field. Additionally, or alternatively, the computing system 200 may create one or more lookup files that can be encrypted as a single entity and for use for searching for the encrypted application-level data.

In some examples, to further enhance the security of the computing system 200, the key management system 210 may, in accordance with the techniques of the present disclosure, ensure that no entity can use or manipulate the key metadata stored by a third-party application to retrieve information about the key or perform unauthorized actions using another user's information to access its key. In some cases, if the key management system 210 or the cloud platform 205 detects any form of unauthorized modification of a respective key, the key management system 210 may revoke and destroy the respective key. In some examples, to enable such security for the key management system 210, the key management system 210 may implement authenticated encryption with associated data (AEAD) techniques. Further, the key management system 210 may receive an additional authenticated data (AAD) string as part of an encrypt or decrypt request. In some cases, the key management system 210 may use the AAD as an integrity check and the key management system 210 may use the AAD to help protect the keys within the key management system 210 from one or more security threats.

In some examples, in accordance with the techniques of the present disclosure, the key management system 210 may utilize an AAD feature which allows the key management system 210 to detect any tampering with database metadata in the key management system 210. In some cases, such features may protect the metadata of both namespace keys and tenant master keys when stored in the keys database 240 of the key management system 210. Additionally, or alternatively, the key management system 210 may protect one or more different keys in the key hierarchy by storing them encrypted in a database managed by a third-party. Further, with AAD, a malicious actor that has access to the database may be unable to manipulate the metadata fields to validate unauthorized access to encrypted data, thus managing to obtain rights to decrypt the data. Therefore, the techniques of the present disclosure may ensure that the key management system 210 protects keys from tampering by utilizing a zero trust architecture, whereby the integrity of each key is protected during the entire lifetime of the key, regardless of the different third parties that have access to the encrypted database.

In some examples, in accordance with the techniques of the present disclosure, the computing system 200 may also implement one or more performance management techniques. In some cases, a first performance management technique may be associated with caching keys in memory of the service 220 associated with the server 215, the key management system 210, or both. Therefore, keys used in moderate to high authentication velocity tenants may remain in the service memory of the key management system 210 in a clear-text form. Based on having the keys cached in the clear-text form (e.g., decrypted form), lower level keys may be able to be quickly decrypted without having to retrieve and decrypt the higher level key. For example, if the key management system 210 caches the decrypted version of a namespace key, when the key management system 210 receives a request to decrypt a data encryption key associated with the namespace key, the key management system 210 may be capable of decrypting the data encryption key without any additional calls, thus increasing the efficiency of key decryption within the computing system 200.

In some cases, to balance key security with performance, cache time may be limited based on last key usage. For example, a key may be wiped from the memory five minutes after a last use. Thus, caching may primarily benefit moderate and high velocity tenants that utilize the same keys relatively frequently. Further, the computing system 200 may establish limits to how much memory can be dedicated to key caching based on the quantity of tenants in an environment. For example, as the quantity of tenants utilizing the key management system 210, the duration that a key may be cached for may decrease. Additionally, or alternatively, for security purposes, in-memory key cache may have to be marked as non-pagable to ensure that keys in memory are unable to get written to disk in a page file.

In another example, the key management system 210 may provide load oriented performance management techniques. For example, encryption operations on keys may be of a fixed size and may have a constant cost. Further, encryption costs of customer data may vary by the data length. Therefore, since the key management system 210 is a central component, having a multi-dimensional variable cost can have potential negative consequences on the key management system 210. In some cases, to manage performance of the distinct load types that could impact the key management system 210, the EaaS can be separated from the key management system 210. For example, due to the differences of load variability when encrypting and decrypting keys vs encrypting and decrypting variable length data having the EaaS calls run in a service container separate from the key management system 210 may be relatively beneficial. Further, the separation may allow for different scaling models and can also allow for scaling only the parts of the service that needs scaling instead of scaling everything. Moreover, having a federated EaaS run in different scaling pools to serve different services may prevent any single service from overloading and taking down all services using EaaS within the computing system 200. In some other cases, to manage performance of the distinct load types that could impact the key management system 210, the data encryption functions can move from EaaS to the Encryption SDK (e.g., the SDK 235). For example, services that need to encrypt or decrypt large chunks of data (e.g., files), placing the data encryption and decryption routines directly in some versions of the Encryption SDK may improve the performance of the computing system 200. Moreover, such performance improvements may enable the computing system 200 the capability to perform relatively large load cryptography to manage its own load and performance without impacting the key management system 210 or EaaS components.

Additionally, or alternatively, in accordance with the techniques of the present disclosure, the key management system 210 may be capable of providing users or tenants with observations associated with the key management system 210. For example, the key management system 210 may be capable of displaying an indication of a quantity of encryptions and decryptions requested by a respective tenant for a duration (e.g., time period). In some cases, usage patterns may vary based on an environment associated with a tenant and thus tenants may be capable of using such pattern indications to determine how to manage data and use of the key management system 210.

Therefore, in accordance with the techniques of the present disclosure, implementing the key management system 210 within the computing system 200 may improve the security of the computing system 200 by introducing a multi-level security key hierarchy that can reduce the risk and vulnerability of the computing system 200. For example, the key management system 210 may limit the impact and probability of security incidents and may improve incident response. Further, the key management system 210 may fulfill customer expectations by allowing users or tenants to have the cloud platform 205 create a root key for the key management system 210, allowing tenants to have control of their own root key for the key management system 210, or for establishing the root key for the key management system 210 within the cloud platform 205 or a platform local to the tenant. Moreover, such capabilities of the key management system 210 may provide the computing system 200 with crypto-agility and the ability to provide relatively efficient and reliable data security as technologies advance. Further descriptions of the techniques of the present disclosure may be described elsewhere herein, such as with reference to FIG. 3. FIG. 3 may illustrate and describe the key hierarchy of the key management system 210 in further detail.

FIG. 3 shows an example of a key hierarchy diagram 300 that supports a hierarchical key management system in accordance with aspects of the present disclosure. In some examples, the key hierarchy diagram 300 may implement or be implemented by the computing system 100, the computing system 200, or both. For example, the key hierarchy diagram 300 may illustrate a root key 305 stored within a cloud platform 205, one or more tenant keys 310 and one or more namespace keys 315 (e.g., a namespace key 315-a, a namespace key 315-b, and a namespace key 315-c) stored within a key management system 210, and one or more data encryption keys 320 (e.g., a data encryption key 320-a and a data encryption key 320-b) used to encrypt one or more data items 325 (e.g., a data item 325-a, a data item 325-b, a data item 325-c) that are both stored at a server 215 associated with an SDK 235. Further, it should be understood by one having ordinary skill in the art that the key hierarchy diagram 300 illustrated herein may be an example of a key hierarchy implemented by a key management system 210 and a key hierarchy may have any quantity of keys and levels for key management.

In some examples, as described herein, a key management system 210 may implement a key hierarchy where lower-level keys are wrapped and encrypted by higher-level keys. Further, each layer of the key hierarchy may serve one or more purposes or goals related to the security of data for a tenant. Moreover, the scope of the keys and the corresponding data the key protects may decrease as the levels within the key hierarchy decrease such that lower-level keys may have relatively low sensitivity, and high-level keys may be relatively sensitive.

In some examples, the key hierarchy diagram 300 may illustrate secure storage and management of cryptographic keys using a namespace-based key hierarchy system to ensure segregation, scalability, security, and performance. Encryption namespace may provide an abstraction for developers to segregate data based on different security levels and may use envelope encryption to provide encryption at scale.

At the top of the key hierarchy diagram 300 may be an environment root key (ERK) or root key 305. In some cases, the root key 305 may be a fixed key owned by an authentication service and managed by the third-party vendors associated with the cloud platform 205. Further, the root key 305 may be stored in a cloud-native HSM provided by a respective cloud platform 205. The HSM may represent a universally trusted component within an architecture that hosts the root key 305 and makes the services of the root key 305 available to the key management system 210 while refraining from exposing the root key 305 outside the cloud platform 205. That is, the root key 305 may not be shared anywhere outside the cloud platform.

In some examples, the root key 305 may be provided to a key management system 210 via a bring your own key (BYOK) procedure where a tenant provides the root key 305. In some cases, the root key 305 may be a remote hosted key hosted by a customer. In another case, the remote key may be supplied by a customer or tenant and provided to the cloud platform 205. Additionally, or alternatively, the root key 305 may be controlled by a customer and an identity management platform associated with the cloud platform 205 may be unable to control the root key 305.

Further, the root key 305 may be used to encrypt and decrypt (e.g., wrap and unwrap) one or more tenant keys 310 (e.g., tenant master keys). In some cases, each tenant utilizing the key management system 210 may be associated with a respective tenant key 310. In some examples, the tenant key 310 may be wrapped by the root key 305 and stored within the key management system 210 of the corresponding vendor for the cloud platform 205 that stores the root key 305. Further, the tenant key 310 may function as an encryption key for one or more namespace keys 315 stored in the key management system 210. For example, the tenant key 310 may encrypt the namespace key 315-a, the namespace key 315-b, and the namespace key 315-c.

In some cases, whenever the key management system 210 has to unlock access or decrypt a respective tenant key 310, the key management system 210 may have to provide the respective tenant key 310 to the HSM and have the HSM decrypt the respective tenant key 310 using the root key 305. Once the respective tenant key 310 is decrypted, the key management system 210 may subsequently use the decrypted tenant key 310 to decrypt signing keys and one or more namespace keys 315 for the respective tenant for use in signing and validating tokens or encrypting and decrypting data encryption keys 320 that encrypt data.

In some examples, the one or more namespace keys 315 may be for namespaces that are used to segregate data based on security level and to enforce security-based access control. In the key management system 210, the one or more namespace keys 315 may be used to provide an indication of granularity therefore enforcing the principle of least privilege. Further, the data encrypted using one namespace key 315 may be unable to be decrypted using a different namespace key 315.

In some examples, namespace keys 315 may represent the mechanism to encrypt data for storage. In some cases, each namespace of a namespace key 315 may be a data type domain that is different from other namespaces. To store secret data, the data should be encrypted and stored using a namespace key 315 configured for encrypting secret data. Further, for personal data and private (e.g., personal identifiable information (PII) data), the data should be encrypted using a namespace key 315 configured for encrypting PII. Moreover, by separating data into different namespaces, customers or tenants can selectively choose to crypto-shred PII while maintaining secrets or vice versa. Additionally, or alternatively, namespaces may also serve as a risk reduction, providing security isolation of different types of customer data. For example, a compromise of a data encryption key 320 is limited to that single tenant and to a namespace key 315 associated with the single tenant, thus limiting the risk of exposing data associated with other namespaces and other tenants.

Further, the one or more namespace keys 315 may be used as encryption keys to encrypt data encryption keys 320, allowing easier and more scalable key rotation and revocation. For example, the namespace key 315-a may encrypt the data encryption key 320-a and the data encryption key 320-b. The one or more data encryption keys 320 may also be referred to as application/field level encryption keys. In some cases, the one or more data encryption keys 320 may be generated in the key management system 210 and can be used to encrypt secrets in different databases. Further, data items 325 may be encrypted using a respected data encryption key 320 by utilizing envelope encryption as a service for key management in the key management system 210, as described with reference to FIG. 2.

The final level of the key hierarchy diagram 300 in may be the data encryption keys 320. In some examples, the data encryption keys may be the only keys that can be shared outside the key management system 210 and can leave the key management system 210 unencrypted. Further, by having the data encryption keys 320 at the bottom of the key hierarchy diagram 300 to encrypt the one or more data items 325, the structure of the key management system 210 may be relatively simple. For example, by having the SDK 235 store a respective data encryption key 320 with the data it encrypts, if the data record is no longer needed, the respective data encryption key 320 will also be automatically deleted (e.g., cleaned up). Additionally, or alternatively, because each unit of data being encrypted is associated with a respective data encryption key 320, two elements of the same exact clear data are guaranteed to be unique in encrypted form. Further, the data encryption keys 320 may be used to encrypt a set of data items 325. For example, as illustrated, the data encryption key 320-b may be used to encrypt the data item 325-a, the data item 325-b, and the data item 325-c which may be related data items 325.

Further, to perform the encryption of the data items 325 and the one or more keys within the key hierarchy diagram 300, one or more encryption algorithms may be implemented by the cloud platform 205, the key management system 210, and the SDK 235 accordingly. In some cases, different encryption algorithms may be used for encrypting different keys and data or the same encryption algorithm may be used to encrypt each key and data item 325 within the key hierarchy diagram 300.

Moreover, when using a key encrypting key (KEK) and data encrypting key (DEK) scheme, a computing system may perform one or more key rotation procedures. In some cases, a key rotation procedure may be considered completed when the KEK is rotated. However, in accordance with the techniques of the present disclosure to rotate DEKs to effect KEK rotation, only the KEK needs to be changed. For example, for a namespace key 315 rotation, the current version of the namespace key 315 may have an origination period terminated and can be rotated to a namespace key 315 history. In response a subsequent (e.g., new) version of the namespace key 315 may be created and starts its origination period. In some cases, the namespace key 315 history contains the old versions of that respective namespace key 315 for the duration of their respective recipient periods. Moreover, such key rotation process may thus remove any need to re-encrypt the data encryption keys 320 associated with the rotate namespace key 315 or to re-encrypt the corresponding data items 325.

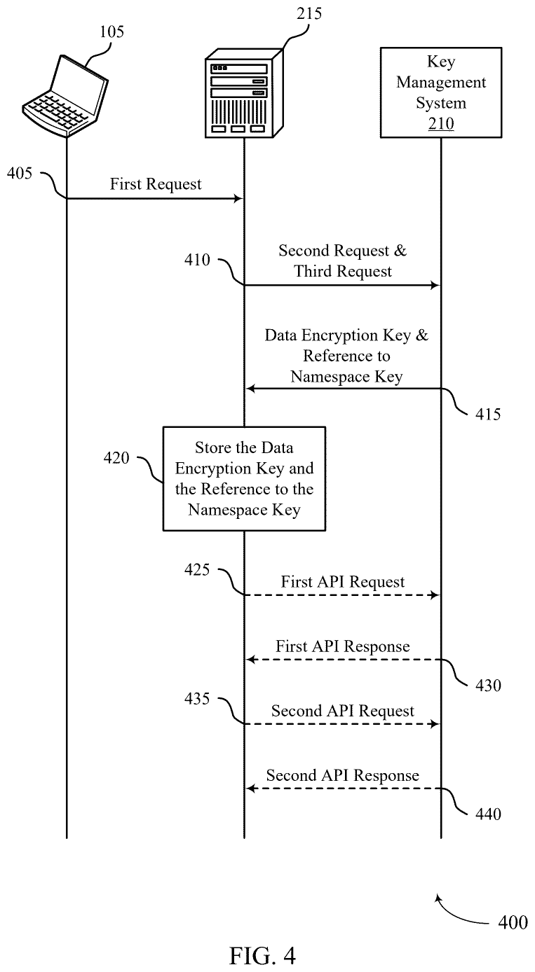

Thus, utilizing the key hierarchy illustrated within the key hierarchy diagram 300, to add tenants or migrate tenant data associated with a respective tenant key 310, the key management system 210 may be capable of rotating the tenant key 310 without having to re-encrypt the one or more namespace keys 315, the one or more data encryption keys 320, and the one or more data items 325 associate the respective tenant key 310. Preventing such re-encryptions may reduce the time consumption and complexity of key rotations and enable the capability to have a relatively large quantity of keys within an environment. For example, since key rotations in accordance with the techniques of the present disclosure may be relatively simple and may be relatively fast due to preventing re-encryptions of lower-level keys, the techniques of the present disclosure may enable relatively fast key rotations for keys. Therefore, even if a tenant key 310 is associated with a relatively large quantity of namespace keys 315 and data encryption keys 320, a tenant associated with the tenant key 310 may be capable of efficiently and reliably rotating the tenant key 310 to enhance security of the data associated with the tenant. Moreover, such key rotation procedures may ensure that there is relatively minimal delay associated with accessing data after a key rotation procedure is initiated, thus ensuring the reliability of the key management system 210. Further descriptions of the techniques of the present disclosure associated with improving the efficiency and reliability of key management may be described elsewhere herein, such as with reference to FIG. 4.

FIG. 4 shows an example of a process flow 400 that supports a hierarchical key management system in accordance with aspects of the present disclosure. In some examples, the process flow 400 may implement or be implemented by the computing system 100, the computing system 200, the key hierarchy diagram 300, or any combination thereof. For example, the process flow 400 may include a computing device 105, a server 215, and a key management system 210, which may be examples of devices described herein with reference to FIGS. 1 and 2.

In the following description of the process flow 400, the operations between the computing device 105, the server 215, and the key management system 210 may be performed in different orders or at different times. Some operations may also be left out of the process flow 400, or other operations may be added. Although the computing device 105, the server 215, and the key management system 210 are shown performing the operations of the process flow 400, some aspects of some operations may also be performed by one or more other wireless devices.

At 405, the server 215 may receive a first request from a first user associated with the computing device 105. The first request may be for encryption of a set of data. In some examples, the server 215 may be an authentication server, a web server, a cloud-based server, a database server, an application server, a physical server, a virtual server, or any combination thereof.

At 410, the server 215 may transmit a second request to the key management system 210. The second request may be for a data encryption key associated with the set of data indicated via the first request. The key management system 210 may include a key hierarchy for data encryption and decryption. In some examples, the key hierarchy may include a root key, a set of tenant keys, a set of namespace keys that includes the namespace key, and a set of data encryption keys that includes the data encryption key. In some cases, the root key may be associated with each other key in the key hierarchy. Further, each tenant of a set of tenants may be associated with one or more different tenant keys of the set of tenant keys. Additionally, or alternatively, the set of namespace keys may be associated with one or more services, one or more applications, or both. In some examples, the set of namespace keys may include one or more private namespace keys for encryption of private data. Further, the key hierarchy may indicate that one or more data encryption keys of the set of data encryption keys are encrypted by a respective namespace key of the set of namespace keys, one or more namespace keys of the set of namespace keys are encrypted by a respective tenant key of the set of tenant keys, and one or more tenant keys of the set of tenant keys are encrypted by the root key. In some cases, the root key may be hosted by and stored at a cloud platform associated with the key management system 210 or may be associated with the first user associated with the computing device 105. In some other cases, a respective key in the key hierarchy of the key management system 210 may be within a respective state of a set of states. The set of states may include a pre-activation state, an active state, a deactivated state, a destroyed state, or any combination thereof.

At 415, the server 215 may receive, from the key management system 210 and in response to the second request, the data encryption key being associated with encrypting the set of data and a reference of a namespace key. The namespace key may be associated with a different level in the key hierarchy of the key management system 210 than a level of the data encryption key in the key hierarchy of the key management system 210. In some examples, the first user associated with the computing device 105 may be associated with a first tenant and the namespace key may be associated with a tenant key for the first tenant. The tenant key may be associated with a different level in the key hierarchy of the key management system 210 than a level of the namespace key in the key hierarchy of the key management system 210.

At 420, the server 215 may store an encrypted version of the set of data, the data encryption key, and the reference of the namespace key based on receiving the data encryption key from the key management system 210. In some examples, the server 215 may store the data encryption key within one or more caches at the server 215 and at the key management system 210. In some cases, the namespace key may be a first version of the namespace key, and the server 215 may receive, from the key management system 210, an indication of a reference to a second version of the namespace key to associate with the data encryption key based on a key rotation procedure. The second version of the namespace key may be different from the first version of the namespace key. Further, the key rotation procedure may refrain from re-encrypting the encrypted version of the set of data. Moreover, the server 215 may store the first version of the namespace key in a list of previous namespace key versions based on receiving the reference to the second version of the namespace key.

At 425, the server 215 may transmit a first application programming interface (API) request to the key management system 210. The first API request may include the second request. The first API request may be associated with creating the data encryption key associated with the set of data. At 430, the server 215 may receive, from the key management system 210 and in response to the first API request, a first API response. The first API response may include the data encryption key associated with encrypting the set of data into the encrypted version of the set of data and the reference of the namespace key.

At 435, the server 215 may transmit a second API request to the key management system 210. The second API request may include a fourth request for decryption of an encrypted version of the data encryption key to decrypt the encrypted version of the set of data. The fourth request may include an indication of the encrypted version of the data encryption key associated with the encrypted version of the set of data and may include the reference of the namespace key. The server 215 may encrypt the data encryption key to obtain the encrypted version of the data encryption key. At 440, the server 215 may receive, from the key management system 210, a second API response. The second API response may include a decrypted version of the data encryption key in response to the second API request that includes the fourth request. Moreover, the server 215 may transmit the second API request and receive the second APU response based on a decrypted version of a data encryption key being unavailable in a cache at the server 215.

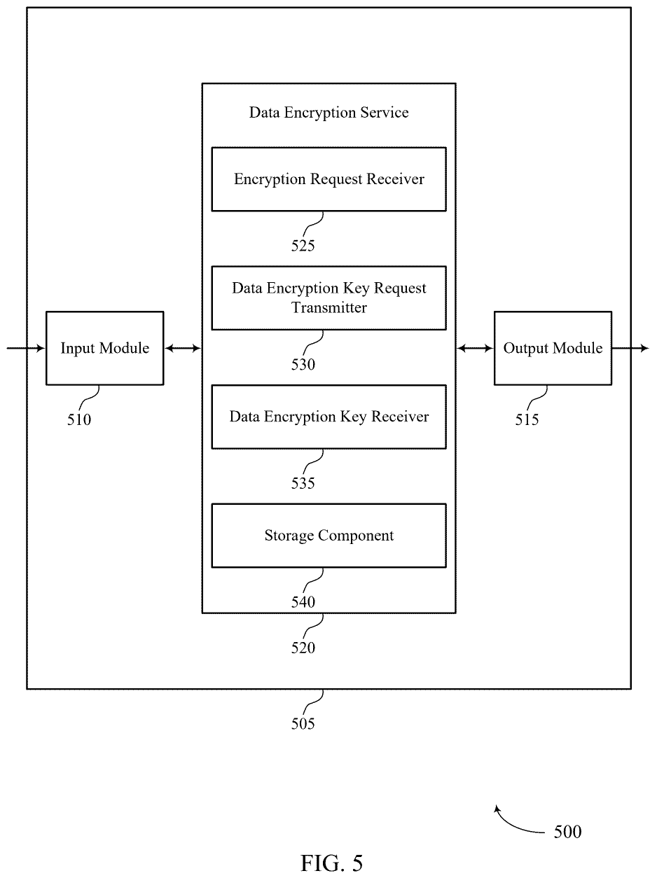

FIG. 5 shows a block diagram 500 of a device 505 that supports a hierarchical key management system in accordance with aspects of the present disclosure. The device 505 may include an input module 510, an output module 515, and a data encryption service 520. The device 505, or one or more components of the device 505 (e.g., the input module 510, the output module 515, the data encryption service 520), may include at least one processor, which may be coupled with at least one memory, to support the described techniques. Each of these components may be in communication with one another (e.g., via one or more buses).

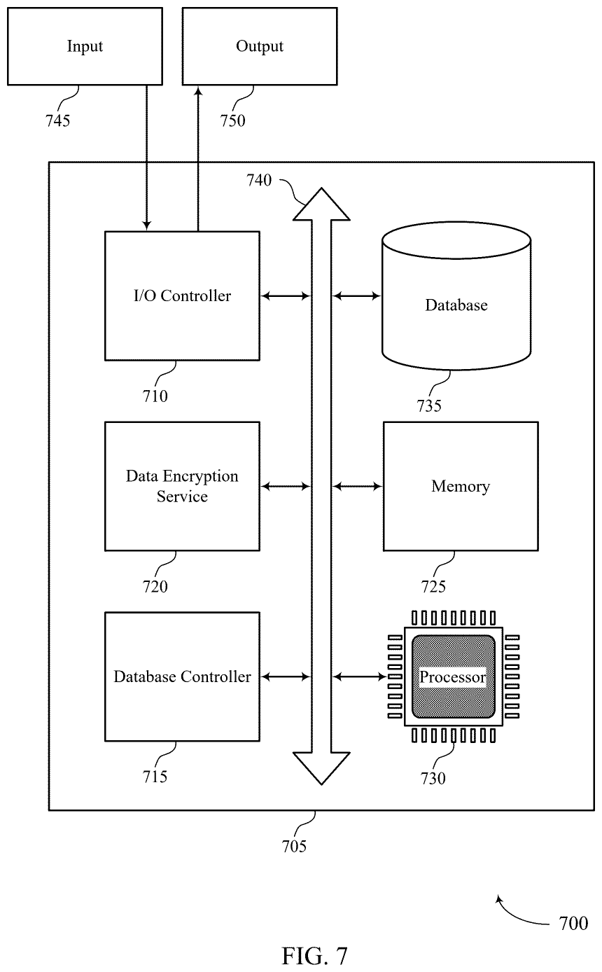

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the data encryption service 520 to support a hierarchical key management system. In some cases, the input module 510 may be a component of an input/output (I/O) controller 710 as described with reference to FIG. 7.

The output module 515 may manage output signals for the device 505. For example, the output module 515 may receive signals from other components of the device 505, such as the data encryption service 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the data encryption service 520 may include an encryption request receiver 525, a data encryption key request transmitter 530, a data encryption key receiver 535, a storage component 540, or any combination thereof. In some examples, the data encryption service 520, or various components thereof, may be configured to perform various operations (e.g., receiving, monitoring, transmitting) using or otherwise in cooperation with the input module 510, the output module 515, or both. For example, the data encryption service 520 may receive information from the input module 510, send information to the output module 515, or be integrated in combination with the input module 510, the output module 515, or both to receive information, transmit information, or perform various other operations as described herein.

The data encryption service 520 may support data encryption in accordance with examples as disclosed herein. The encryption request receiver 525 may be configured to support receiving, at the server, a first request from a first user, the first request for encryption of a set of data. The data encryption key request transmitter 530 may be configured to support transmitting, to a key management system, a second request for a data encryption key associated with the set of data indicated via the first request, the key management system including a key hierarchy for data encryption and decryption. The data encryption key receiver 535 may be configured to support receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system. The storage component 540 may be configured to support storing, at the server, an encrypted version of the set of data, the data encryption key, and the reference of the namespace key based on receiving the data encryption key from the key management system.

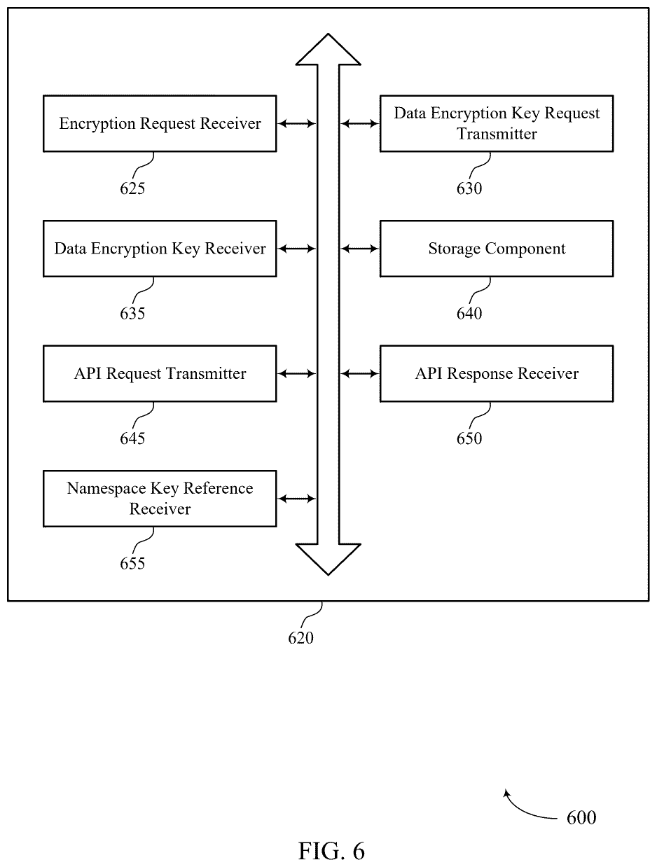

FIG. 6 shows a block diagram 600 of a data encryption service 620 that supports a hierarchical key management system in accordance with aspects of the present disclosure. The data encryption service 620 may be an example of aspects of a data encryption service or a data encryption service 520, or both, as described herein. The data encryption service 620, or various components thereof, may be an example of means for performing various aspects of a hierarchical key management system as described herein. For example, the data encryption service 620 may include an encryption request receiver 625, a data encryption key request transmitter 630, a data encryption key receiver 635, a storage component 640, an API request transmitter 645, an API response receiver 650, a namespace key reference receiver 655, or any combination thereof. Each of these components, or components of subcomponents thereof (e.g., one or more processors, one or more memories), may communicate, directly or indirectly, with one another (e.g., via one or more buses).

The data encryption service 620 may support data encryption in accordance with examples as disclosed herein. The encryption request receiver 625 may be configured to support receiving, at the server, a first request from a first user, the first request for encryption of a set of data. The data encryption key request transmitter 630 may be configured to support transmitting, to a key management system, a second request for a data encryption key associated with the set of data indicated via the first request, the key management system including a key hierarchy for data encryption and decryption. The data encryption key receiver 635 may be configured to support receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system. The storage component 640 may be configured to support storing, at the server, an encrypted version of the set of data, the data encryption key, and the reference of the namespace key based on receiving the data encryption key from the key management system.

In some examples, the API request transmitter 645 may be configured to support transmitting, to the key management system, a first application programming interface (API) request that includes the second request, the first API request associated with creating the data encryption key associated with the set of data. In some examples, the API response receiver 650 may be configured to support receiving, from the key management system and in response to the first API request, a first API response that includes the data encryption key associated with encrypting the set of data into the encrypted version of the set of data and the reference of the namespace key.

In some examples, the API request transmitter 645 may be configured to support transmitting, to the key management system, a second API request that includes a fourth request for decryption of an encrypted version of the data encryption key to decrypt the encrypted version of the set of data, the fourth request including an indication of the encrypted version of the data encryption key associated with the encrypted version of the set of data and including the reference of the namespace key, where the server encrypts the data encryption key to obtain the encrypted version of the data encryption key, and where transmission of the second API request is based on a decrypted version of the data encryption key being unavailable at a cache of the server. In some examples, the API response receiver 650 may be configured to support receiving, from the key management system a, a second API response that includes the decrypted version of the data encryption key in response to the second API request that includes the fourth request.

In some examples, the namespace key is a first version of the namespace key, and the namespace key reference receiver 655 may be configured to support receiving, from the key management system, an indication of a reference to a second version of the namespace key to associate with the data encryption key based on a key rotation procedure, the second version of the namespace key being different from the first version of the namespace key, where the key rotation procedure refrains from re-encrypting the encrypted version of the set of data. In some examples, the namespace key is a first version of the namespace key, and the storage component 640 may be configured to support storing, at the server, the first version of the namespace key in a list of previous namespace key versions based on receiving the reference to the second version of the namespace key.

In some examples, to support storing the data encryption key, the storage component 640 may be configured to support storing the data encryption key within one or more caches at the server and at the key management system.

In some examples, the key hierarchy includes a root key, a set of multiple tenant keys, a set of multiple namespace keys that includes the namespace key, and a set of multiple data encryption keys that includes the data encryption key.

In some examples, the root key is associated with each other key in the key hierarchy.

In some examples, each tenant of a set of multiple tenants is associated with one or more different tenant keys of the set of multiple tenant keys.

In some examples, the set of multiple namespace keys are associated with one or more services, one or more applications, or both.

In some examples, the set of multiple namespace keys includes one or more private namespace keys for encryption of private data.

In some examples, the key hierarchy indicates that one or more data encryption keys of the set of multiple data encryption keys are encrypted by a respective namespace key of the set of multiple namespace keys, one or more name space keys of the set of multiple namespace keys are encrypted by a respective tenant key of the set of multiple tenant keys, and one or more tenant keys of the set of multiple tenant keys are encrypted by the root key.

In some examples, the root key is hosted by and stored at a cloud platform associated with the key management system or is associated with the first user.

In some examples, the first user is associated with a first tenant and the namespace key is associated with a tenant key for the first tenant, the tenant key associated with a different level in the key hierarchy of the key management system than a level of the namespace key in the key hierarchy of the key management system.

In some examples, a respective key in the key hierarchy of the key management system is within a respective state of a set of multiple states, the set of multiple states including a pre-activation state, an active state, a deactivated state, a destroyed state, or any combination thereof.

In some examples, the server is an authentication server, a web server, a cloud-based server, a database server, an application server, a physical server, a virtual server, or any combination thereof.

FIG. 7 shows a diagram of a system 700 including a device 705 that supports a hierarchical key management system in accordance with aspects of the present disclosure. The device 705 may be an example of or include components of a device 505 as described herein. The device 705 may include components for bi-directional voice and data communications including components for transmitting and receiving communications, such as a data encryption service 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting a hierarchical key management system). The processor 730 may be an example of a single processor or multiple processors. For example, the device 705 may include one or more processors 730.

The data encryption service 720 may support data encryption in accordance with examples as disclosed herein. For example, the data encryption service 720 may be configured to support receiving, at the server, a first request from a first user, the first request for encryption of a set of data. The data encryption service 720 may be configured to support transmitting, to a key management system, a second request for a data encryption key associated with the set of data indicated via the first request, the key management system including a key hierarchy for data encryption and decryption. The data encryption service 720 may be configured to support receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system. The data encryption service 720 may be configured to support storing, at the server, an encrypted version of the set of data, the data encryption key, and the reference of the namespace key based on receiving the data encryption key from the key management system.

By including or configuring the data encryption service 720 in accordance with examples as described herein, the device 705 may support techniques for users to encrypt data using a key hierarchy of a key management system to enhance the security of data storage, improve the ability to rotate keys without re-encrypting data, and improving the ability to obtain access to data using one or more keys of the key hierarchy.

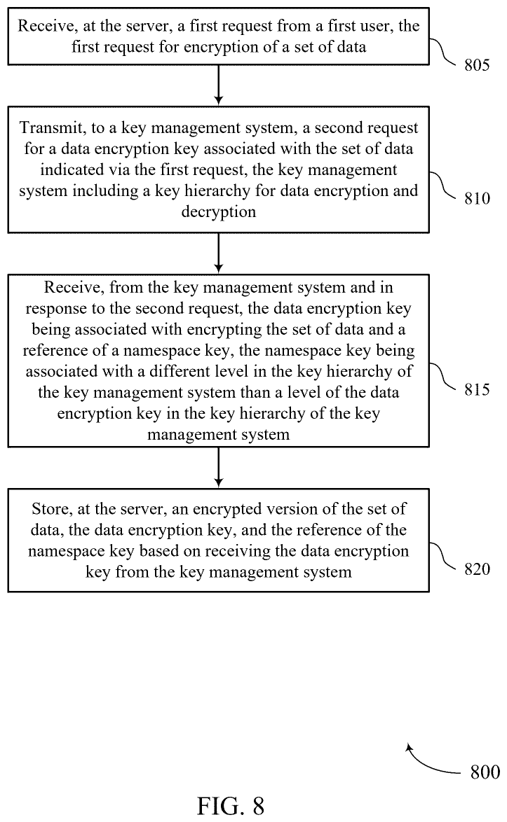

FIG. 8 shows a flowchart illustrating a method 800 that supports a hierarchical key management system in accordance with aspects of the present disclosure. The operations of the method 800 may be implemented by a server or its components as described herein. For example, the operations of the method 800 may be performed by a server as described with reference to FIGS. 1 through 7. In some examples, a server may execute a set of instructions to control the functional elements of the server to perform the described functions. Additionally, or alternatively, the server may perform aspects of the described functions using special-purpose hardware.

At 805, the method may include receiving, at the server, a first request from a first user, the first request for encryption of a set of data. The operations of 805 may be performed in accordance with examples as disclosed herein. In some examples, aspects of the operations of 805 may be performed by an encryption request receiver 625 as described with reference to FIG. 6.

At 810, the method may include transmitting, to a key management system, a second request for a data encryption key associated with the set of data indicated via the first request, the key management system including a key hierarchy for data encryption and decryption. The operations of 810 may be performed in accordance with examples as disclosed herein. In some examples, aspects of the operations of 810 may be performed by a data encryption key request transmitter 630 as described with reference to FIG. 6.

At 815, the method may include receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system. The operations of 815 may be performed in accordance with examples as disclosed herein. In some examples, aspects of the operations of 815 may be performed by a data encryption key receiver 635 as described with reference to FIG. 6.

At 820, the method may include storing, at the server, an encrypted version of the set of data, the data encryption key, and the reference of the namespace key based on receiving the data encryption key from the key management system. The operations of 820 may be performed in accordance with examples as disclosed herein. In some examples, aspects of the operations of 820 may be performed by a storage component 640 as described with reference to FIG. 6.

The following provides an overview of aspects of the present disclosure:

Aspect 1: A method for data encryption at a server, comprising: receiving, at the server, a first request from a first user, the first request for encryption of a set of data; transmitting, to a key management system, a second request for a data encryption key associated with the set of data indicated via the first request, the key management system comprising a key hierarchy for data encryption and decryption; receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system; and storing, at the server, an encrypted version of the set of data, the data encryption key, and the reference of the namespace key based at least in part on receiving the data encryption key from the key management system.

Aspect 2: The method of aspect 1, further comprising: transmitting, to the key management system, a first application programming interface (API) request that comprises the second request, the first API request associated with creating the data encryption key associated with the set of data; and receiving, from the key management system and in response to the first API request, a first API response that comprises the data encryption key associated with encrypting the set of data into the encrypted version of the set of data and the reference of the namespace key.

Aspect 3: The method of aspect 2, further comprising: transmitting, to the key management system, a second API request that comprises a fourth request for decryption of an encrypted version of the data encryption key to decrypt the encrypted version of the set of data, the fourth request comprising an indication of the encrypted version of the data encryption key associated with the encrypted version of the set of data and comprising the reference of the namespace key, wherein the server encrypts the data encryption key to obtain the encrypted version of the data encryption key, and wherein transmission of the second API request is based at least in part on a decrypted version of the data encryption key being unavailable at a cache of the server; and receiving, from the key management system, a second API response that comprises the decrypted version of the data encryption key in response to the second API request that comprises the fourth request.

Aspect 4: The method of any of aspects 1 through 3, wherein the namespace key is a first version of the namespace key, and the method further comprises: receiving, from the key management system, an indication of a reference to a second version of the namespace key to associate with the data encryption key based at least in part on a key rotation procedure, the second version of the namespace key being different from the first version of the namespace key, wherein the key rotation procedure refrains from re-encrypting the encrypted version of the set of data; and storing, at the server, the first version of the namespace key in a list of previous namespace key versions based at least in part on receiving the reference to the second version of the namespace key.

Aspect 5: The method of any of aspects 1 through 4, wherein storing the data encryption key comprises: storing the data encryption key within one or more caches at the server and at the key management system.

Aspect 6: The method of any of aspects 1 through 5, wherein the key hierarchy comprises a root key, a plurality of tenant keys, a plurality of namespace keys that includes the namespace key, and a plurality of data encryption keys that includes the data encryption key.

Aspect 7: The method of aspect 6, wherein the root key is associated with each other key in the key hierarchy.

Aspect 8: The method of any of aspects 6 through 7, wherein each tenant of a plurality of tenants is associated with one or more different tenant keys of the plurality of tenant keys.

Aspect 9: The method of any of aspects 6 through 8, wherein the plurality of namespace keys are associated with one or more services, one or more applications, or both.

Aspect 10: The method of any of aspects 6 through 9, wherein the plurality of namespace keys comprises one or more private namespace keys for encryption of private data.

Aspect 11: The method of any of aspects 6 through 10, wherein the key hierarchy indicates that one or more data encryption keys of the plurality of data encryption keys are encrypted by a respective namespace key of the plurality of namespace keys, one or more name space keys of the plurality of namespace keys are encrypted by a respective tenant key of the plurality of tenant keys, and one or more tenant keys of the plurality of tenant keys are encrypted by the root key.

Aspect 12: The method of any of aspects 6 through 11, wherein the root key is hosted by and stored at a cloud platform associated with the key management system or is associated with the first user.

Aspect 13: The method of any of aspects 1 through 12, wherein the first user is associated with a first tenant and the namespace key is associated with a tenant key for the first tenant, the tenant key associated with a different level in the key hierarchy of the key management system than a level of the namespace key in the key hierarchy of the key management system.

Aspect 14: The method of any of aspects 1 through 13, wherein a respective key in the key hierarchy of the key management system is within a respective state of a plurality of states, the plurality of states comprising a pre-activation state, an active state, a deactivated state, a destroyed state, or any combination thereof.

Aspect 15: The method of any of aspects 1 through 14, wherein the server is an authentication server, a web server, a cloud-based server, a database server, an application server, a physical server, a virtual server, or any combination thereof.

Aspect 16: A server for data encryption, comprising one or more memories storing processor-executable code, and one or more processors coupled with the one or more memories and individually or collectively operable to execute the code to cause the server to perform a method of any of aspects 1 through 15.

Aspect 17: A server for data encryption, comprising at least one means for performing a method of any of aspects 1 through 15.

Aspect 18: A non-transitory computer-readable medium storing code for data encryption, the code comprising instructions executable by one or more processors to perform a method of any of aspects 1 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data encryption at a server, comprising:
receiving, at the server, a first request from a first user, the first request for encryption of a set of data;
transmitting, to a key management system, a second request for a data encryption key associated with the set of data indicated via the first request, the key management system comprising a key hierarchy for data encryption and decryption;
receiving, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system; and
storing, at the server, an encrypted version of the set of data, the data encryption key, and the reference of the namespace key based at least in part on receiving the data encryption key from the key management system.

2. The method of claim 1, further comprising:
transmitting, to the key management system, a first application programming interface (API) request that comprises the second request, the first API request associated with creating the data encryption key associated with the set of data; and
receiving, from the key management system and in response to the first API request, a first API response that comprises the data encryption key associated with encrypting the set of data into the encrypted version of the set of data and the reference of the namespace key.

3. The method of claim 2, further comprising:
transmitting, to the key management system, a second API request that comprises a fourth request for decryption of an encrypted version of the data encryption key to decrypt the encrypted version of the set of data, the fourth request comprising an indication of the encrypted version of the data encryption key associated with the encrypted version of the set of data and comprising the reference of the namespace key, wherein the server encrypts the data encryption key to obtain the encrypted version of the data encryption key, and wherein transmission of the second API request is based at least in part on a decrypted version of the data encryption key being unavailable at a cache of the server; and
receiving, from the key management system, a second API response that comprises the decrypted version of the data encryption key in response to the second API request that comprises the fourth request.

4. The method of claim 1, wherein the namespace key is a first version of the namespace key, and the method further comprises:
receiving, from the key management system, an indication of a reference to a second version of the namespace key to associate with the data encryption key based at least in part on a key rotation procedure, the second version of the namespace key being different from the first version of the namespace key, wherein the key rotation procedure refrains from re-encrypting the encrypted version of the set of data; and
storing, at the server, the first version of the namespace key in a list of previous namespace key versions based at least in part on receiving the reference to the second version of the namespace key.

5. The method of claim 1, wherein storing the data encryption key comprises:
storing the data encryption key within one or more caches at the server and at the key management system.

6. The method of claim 1, wherein the key hierarchy comprises a root key, a plurality of tenant keys, a plurality of namespace keys that includes the namespace key, and a plurality of data encryption keys that includes the data encryption key.

7. The method of claim 6, wherein the root key is associated with each other key in the key hierarchy.

8. The method of claim 6, wherein each tenant of a plurality of tenants is associated with one or more different tenant keys of the plurality of tenant keys.

9. The method of claim 6, wherein the plurality of namespace keys are associated with one or more services, one or more applications, or both.

10. The method of claim 6, wherein the plurality of namespace keys comprises one or more private namespace keys for encryption of private data.

11. The method of claim 6, wherein the key hierarchy indicates that one or more data encryption keys of the plurality of data encryption keys are encrypted by a respective namespace key of the plurality of namespace keys, one or more name space keys of the plurality of namespace keys are encrypted by a respective tenant key of the plurality of tenant keys, and one or more tenant keys of the plurality of tenant keys are encrypted by the root key.

12. The method of claim 6, wherein the root key is hosted by and stored at a cloud platform associated with the key management system or is associated with the first user.

13. The method of claim 1, wherein the first user is associated with a first tenant and the namespace key is associated with a tenant key for the first tenant, the tenant key associated with a different level in the key hierarchy of the key management system than a level of the namespace key in the key hierarchy of the key management system.

14. The method of claim 1, wherein a respective key in the key hierarchy of the key management system is within a respective state of a plurality of states, the plurality of states comprising a pre-activation state, an active state, a deactivated state, a destroyed state, or any combination thereof.

15. The method of claim 1, wherein the server is an authentication server, a web server, a cloud-based server, a database server, an application server, a physical server, a virtual server, or any combination thereof.

16. A server for data encryption, comprising:
one or more memories storing processor-executable code; and
one or more processors coupled with the one or more memories and individually or collectively operable to execute the code to cause the server to:
receive, at the server, a first request from a first user, the first request for encryption of a set of data;
transmit, to a key management system, a second request for a data encryption key associated with the set of data indicated via the first request, the key management system comprising a key hierarchy for data encryption and decryption;
receive, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system; and
store, at the server, an encrypted version of the set of data, the data encryption key, and the reference of the namespace key based at least in part on receiving the data encryption key from the key management system.

17. The server of claim 16, wherein, to store the data encryption key, the one or more processors are individually or collectively operable to execute the code to cause the server to:
store the data encryption key within one or more caches at the server and at the key management system.

18. The server of claim 16, wherein the key hierarchy comprises a root key, a plurality of tenant keys, a plurality of namespace keys that includes the namespace key, and a plurality of data encryption keys that includes the data encryption key.

19. The server of claim 16, wherein the first user is associated with a first tenant and the namespace key is associated with a tenant key for the first tenant, the tenant key associated with a different level in the key hierarchy of the key management system than a level of the namespace key in the key hierarchy of the key management system.

20. A non-transitory computer-readable medium storing code for data encryption, the code comprising instructions executable by one or more processors to:
receive, at a server, a first request from a first user, the first request for encryption of a set of data;
transmit, to a key management system, a second request for a data encryption key associated with the set of data indicated via the first request, the key management system comprising a key hierarchy for data encryption and decryption;
receive, from the key management system and in response to the second request, the data encryption key being associated with encrypting the set of data and a reference of a namespace key, the namespace key being associated with a different level in the key hierarchy of the key management system than a level of the data encryption key in the key hierarchy of the key management system; and
store, at the server, an encrypted version of the set of data, the data encryption key, and the reference of the namespace key based at least in part on receiving the data encryption key from the key management system.
